(19) United States
(12) Patent Application Publication
(10) Pub. No.: US 2012/0275688 A1
(43) Pub. Date: Nov. 1, 2012

(54) METHOD FOR AUTOMATED 3D IMAGING

(75) Inventors: Maxwell Leslie STAINLAY, Port Douglas (AU); George Madimir POROPAL, Petrie Terrace (AU)

(73) Assignee: Commonwealth Scientific and Industrial Research Organisation, Port Douglas (AU)

(21) Appl. No.: 13/545,888

(22) Filed: Jul. 10, 2012

Related U.S. Application Data
(63) Continuation of application No. 11/665,255, filed on Jun. 5, 2007, now abandoned.

(30) Foreign Application Priority Data
Aug. 30, 2004 (AU) 2004904912

(51) Int. Cl. G06K 9/00

(52) U.S. Cl. 382/154

(57) ABSTRACT

A method for automated construction of 3D images is disclosed, in which a range measurement device is to initiate and control the processing of 2D images in order to produce a 3D image. The range measurement device may be integrated with an image sensor, for example the range sensor from a digital camera, or may be a separate device. Data indicating the distance to a specific feature obtained from the range sensor may be used to control and automate the construction of the 3D image.

### CROSS-REFERENCE

This application is a continuation of U.S. patent application Ser. No. 11/665,255, filed Jun. 5, 2007 (now abandoned) which is the national phase application of International Application PCT/AU2005/001316, filed Aug. 30, 2005 which designated the U.S. and claims benefit of AU 2004904912, filed Aug. 30, 2004, the entire contents of each of which are hereby incorporated by reference in this application.

### TECHNICAL FIELD

The present invention relates to the automated construction of 3D surface image data from digital images.

### BACKGROUND ART

The characterisation of the shape of the surface of an object (the surface topography of the object) is required to perform many tasks. Many methods for obtaining information describing the shape of the surface of an object are known. For example, the shape of the surface of the object may be measured using photogrammetric means or using a scanned laser measurement device. In many cases additional data characterising the visual nature of the surface or other properties of the surface are also required. Many methods for obtaining information describing the visual characteristics of the surface of an object are also known.

Using photogrammetric means, three-dimensional spatial data may be acquired from two or more two dimensional images. The prior art requires that the position and orientation of the lines of sight of the cameras or, in cases where one camera is used the position and the line of sight of the camera at each imaging location, are known.

According to prior art techniques, the construction of a three dimensional image from two or more two dimensional images requires the determination of points of correspondence in both images and the application of well known mathematical formulae to use knowledge of the positions of correspondence to estimate absolute or relative spatial position of points for which correspondences are determined.

This process requires significant processing power to be deployed. The processing is performed to determine single or multiple correspondences within images of a scene. A ‘global’ search for correspondences must be performed, and may produce many correspondences some of which will be false or may not be unique.

It is an object of the present invention to provide an improved process for constructing three dimensional surface images from sensor data where the sensor data may be two or more images.

### SUMMARY OF INVENTION

In a broad form, the present invention uses the sensed distance or distances to a known feature or features in an image to initiate and control the processing of two dimensional image data to produce three dimensional surface data.

According to one aspect, the present invention provides a method for processing sets of two dimensional image data obtained from at least a first and a second two-dimensional image of an object acquired using one or more image sensors located at a first and a second position so as to produce three dimensional surface data, the method including the steps of:

(a) Acquiring range data indicative of the distance from the image sensor to at least one known feature in each two dimensional image;

(b) Determining the relative displacement of the image sensor at the first and the second position;

(c) Processing the two dimensional image data using the range data and the relative displacement to initiate and control determination of correspondences between the two dimensional image data so as to produce processed image data; and

(d) Integrating the processed image data to produce three dimensional surface data.

Preferably but not necessarily, the two dimensional image data may be further integrated with data defining the visual characteristics or other characteristics of the surface such as reflectance or emission in other bands of the electromagnetic spectrum.

The three dimensional surface data consists of the spatial data defining the shape of an object (or objects), optionally integrated with the visual data or other data that has the format of a visual image, such as spectral data from spectral regions other than those of visual wavelengths defining the reflective or emissive nature of the object.

The range data may be acquired directly from the image sensor, or a separate sensor, and may require integration with data about the orientation and position of the camera.

According to one implementation of the present invention, a range measurement device or the projection of a light pattern is used to control the initiation of processing to extract three-dimensional spatial data, and as required, construct a three-dimensional image from two images.

A three dimensional image is the integrated description of a surface combining spatial data and data such as visual data. The range measurement data allows the processor to more readily determine single or multiple correspondences within images of a scene. Without knowledge of the distance to a feature that is present in the images being processed, as in the prior art, a ‘global’ search for correspondences must be performed even when the position and orientation of the cameras is known. Such a search may produce many correspondences some of which will be false or may not be unique.

Knowledge of the distance to a known point, or points, combined with knowledge of the relative orientation and position of the cameras (relative orientation and position may be derived mathematically or may be determined from a knowledge of absolute position and orientation) and the range measurement device or light projection device may be used to control the search for correspondences since if the position (relative or absolute) in space of a feature in one image is known the position of said feature in a second image is known. This knowledge is then used to control and automate the processing that determines the correspondences necessary to create a three-dimensional image.

According to the present invention the use of knowledge of the distance or distances to a known feature or features in an image can be obtained by the projection of a known pattern of light into the space in which the 3D image is to be created. In this method the location of the image of the pattern of light is used to then determine the distance or distances to a feature or a set of features in a two dimensional image using methods known in the prior art and the process described for use with direct measurement of range to said features may then be applied.

The present invention further encompasses an apparatus and system for producing three dimensional surface data, and a software product operatively adapted to carry out the inventive method.

It will be understood that the term object as used in relation to the subject of an image is intended broadly, and may encompass geographic features and terrain as well as specific objects and features in images. The term three dimensional surface data is used broadly to mean data characterising the shape and optionally other characteristics of the surface of an object.

### BRIEF DESCRIPTION OF DRAWINGS

The present invention will now be described with reference to the accompanying drawings, in which:

FIG. 1 is a representation of a typical three-dimensional imaging system (sensor) as it may be implemented using a single sensor;

FIG. 2 is a representation of a 3D imaging system (sensor) utilising two sensors e.g. two cameras as used in a stereo-imaging sensor wherein the field of view of the 3D sensor is defined by the overlap of the field of view of the individual sensors; and

FIG. 3 is a representation of a 3D imaging system (sensor) utilising two cameras used at two locations or one camera used at two locations; and

FIG. 4 is a block diagram of a suitable system according to one embodiment.

FIG. 5 is an image of one implementation of an automated 3D imaging system using two cameras and a laser range finder (centre).

FIG. 6 is a computer representation of a 3D image created by the implementation of an automated 3D imaging system as shown in FIG. 5.

FIG. 7 is a representation of the 3D data component of a 3D image as a spatial point cloud, i.e. a visualisation of the spatial location of each surface point of the 3D image.

### DETAILED DESCRIPTION

Whilst the operation of the invention is described with reference to some particular implementations, it will be appreciated that many alternative implementations are possible.

In the conventional application of techniques of photogrammetry the relative positions and orientations of the cameras when two or more cameras are used or the positions and orientations of the camera when only one camera is used are determined and the images are sampled in accordance with the epipolar geometry determined by the relative positions and orientations of the cameras or the camera when one camera is used and a disparity map is created. The disparity map is used to extract three-dimensional spatial data using the relative positions and orientations of the cameras.

In the conventional application the search for correspondences is initiated by a number of means and is performed by many methods. The search for correspondences is computationally intensive. To reduce the computation the search can be constrained by the geometry of the cameras wherein the cameras are used in a fixed known geometrical relationship or the search can be initiated under the control of a human.

Conventionally range information is not acquired and is not used to control the process of construction of a disparity map. The disparity map is generated for all points common to both images after resampling of the images in accordance with the epipolar geometry. Once the disparity map has been generated three-dimensional spatial data is generated from the disparity map.

In the present invention the range measurement and the relative positions and orientations of the cameras are used to initiate and control the search process that produces the disparity information. The use of this control enables the automated generation of a three dimensional image.

It will be understood that while the present invention is an improvement to conventional techniques, the general principles and techniques of known systems are relevant to and form part of the practical implementation of the present invention.

Photogrammetry is effectively a triangulation system that requires that there are two, or more, components of the sensor which enable the determination of the direction in three dimensions to a point in the object space. The position and orientation of each component of the sensor is known and, since for each component of the sensor the angular direction to the point is known, the position in space of the point is readily determined thus providing a three dimensional image. Triangulation may be subdivided into techniques: passive triangulation and active triangulation.

Passive triangulation encompasses such techniques as aerial or terrestrial photogrammetry where the components of the measurement system are two or more cameras, or one camera taking two or more images. Points in each image are matched and from the position in each image of the matched points the spatial position is determined. Fast systems using two television cameras and image processing systems are sometimes classified as stereovision.

Active triangulation encompassed such techniques as structured light imaging where a light stripe is projected into an object space and viewed by a camera or similar sensor from another position. In some instances two cameras are used. Knowledge of the direction of projection of the light stripe and the position and orientation of the camera or cameras enables calculation of the position in space of any point reflecting the light. Another form of active triangulation involves the use of a spot of light scanned over the object space.

Those skilled in the art will be aware of these and other alternative 3D imaging techniques which can be employed to implement the present invention. These are discussed, for example, in Besl, P. J., Active Optical Range Imaging Sensors; Machine Vision and Applications Vol 1 1988.

The possible implementations of the present invention will now be described in more detail. It is emphasised that apart from the range determining device, the remainder of the system is conventional and may be implemented using well known approaches.

FIG. 1 is schematic view showing the typical field of view for a single device implementation of the present invention, for example using a laser rangefinder. Such a device inherently provides three dimensional position information about the surfaces sensed.

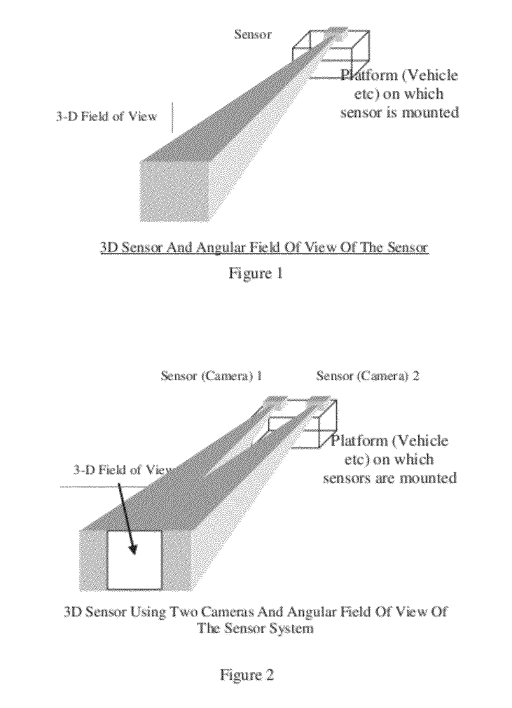

FIG. 2 shows an imaging system utilising two sensors, such as digital cameras used in a stereo imaging configuration. The field of view of the combined sensors, i.e. where they overlap, defines the 3D sensing zone. Range information in this case is provided by the automated range determining mechanism from each camera, together with information about the alignment and position of each sensor on the platform.

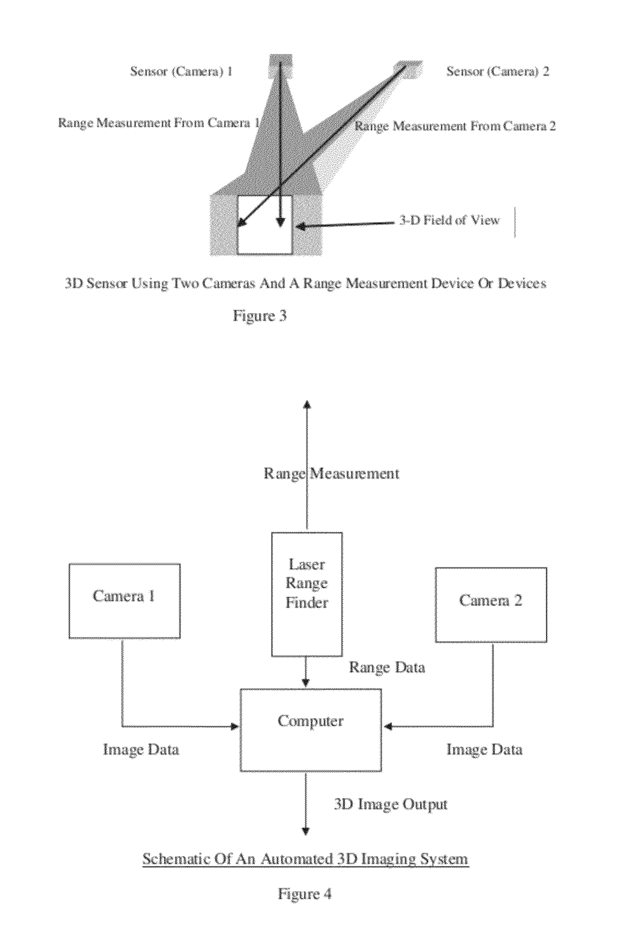

FIG. 3 shows another arrangement, using either one camera at two locations or two cameras at different locations. A range measurement device is collocated with the camera at each location. Again, the field of view of the 3D sensor is defined by the overlap between the fields of view of the cameras.

Two methods for automated creation of three dimensional images will be described below:

a) Using a 3D imaging sensor that combines a range measurement device and a sensor that is capable of producing a visual representation or other representation for example a spectral representation using wavelengths other than visual light of a scene. An example of such a sensor is a two-dimensional imaging sensor as in a digital camera, and the range measurement device in the camera may provide the range measurement. The range and image data enables the 3D image to be automatically constructed.

b) Using a 3D imaging sensor that combines a mechanism for projecting a known pattern of light into the space in which a three dimensional image is to be constructed and a sensor that is capable of producing a visual representation or other representation for example a spectral representation using wavelengths other than visual light of a scene such as a two-dimensional imaging sensor as in a digital camera is used to acquire data from which the 3D image is automatically constructed.

In the preferred embodiment, the process of creating a 3D image is undertaken as follows when a range measurement device is used. In the description provided the use of two images is assumed the process may obviously be readily extended to the use of more than two images.

1. A sensor is used to acquire a two dimensional image of a scene.

2. A sensor is used to acquire a second two dimensional image of an overlapping section of the scene.

3. A range measurement device that may be collocated with the sensor or may be positioned at a known position relative to the sensor determines the distance to a feature or features in the scene. Knowledge of the spatial relationship is then used to predict the position of the feature to which the range has been measured in both images.

4. A processor locates these features in the two dimensional images using the knowledge of the distance to these features obtained by measurement using the range finder.

5. The processor uses knowledge of the position of these features in both image to control the process of image data to locate correspondences in the two images that are used to create a three dimensional image.

6. The processor determines all possible correspondences between the two images

7. The correspondences are used with the data defining the position and orientation of the sensors to create a three dimensional image.

A preferred practical implementation of the present invention requires the following components.

First, a means for acquiring two dimensional digital images is required. A suitable device is a digital camera or camera, with an appropriate data interface to output image data.

A means for measuring distance to an object from a camera in a direction relative to the camera that is known and aligned to the camera is required. This may be done using the existing range measurement device in most digital cameras. Such devices are used to provide auto-focusing in many cameras and may be an ultrasonic range measurement system or may utilise an image processing algorithm that determines when the camera is properly focussed and infers the range from the focus setting.

One alternative is to use a device which projects a known pattern of light (or other radiation) into the scene space, the range being determined by the reflected light sensed by the device in response to the known output.

A suitable processor is required. The nature of the processor is to an extent dependant upon the size of the operating field and the volume of data being processed. For processing of relatively small images an embedded digital signal processor may be used in local equipment. For large images a computer such as a personal computer may be required.

Means for storing data acquired by the imaging system and other data is required, of a capacity and speed compatible with the required application.

The automated 3D image construction is performed by a suitable algorithm to be executed by the processor. Such algorithms are known in the prior art and are embodied in systems in the following form:
1. The algorithm estimates the disparity between two images by performing correlation of similar features in the images
2. The disparity between two images is used with knowledge of the spatial relationship between the cameras to determine the position in space relative to the cameras of the features in the images for which the disparity has been estimated.

An embodiment of the system is shown in FIG. 4.

In the preferred embodiment, the process of creating a 3D image is undertaken as follows, when a mechanism for projecting light pattern into the space in which a three dimensional image is to be constructed is used:

1. A sensor is used to acquire a two dimensional image of a scene that may include a projected light pattern.

2. A sensor is used to acquire a second two dimensional image of an overlapping section of the scene that may include a projected light pattern.

3. A processor locates features in the images that correspond to the projected light pattern and determines the distance to these features as is well known in the prior art (e.g. Close Range Photogrammetry and Machine Vision edited by K. B. Atkinson).

4. The processor uses knowledge of the position of these features in both image to control the process of image data to locate correspondences in the two images that are used to create a three dimensional image.

5. The processor determines all possible correspondences between the two images

6. The correspondences are used with the data defining the position and orientation of the sensors to create a three dimensional image.

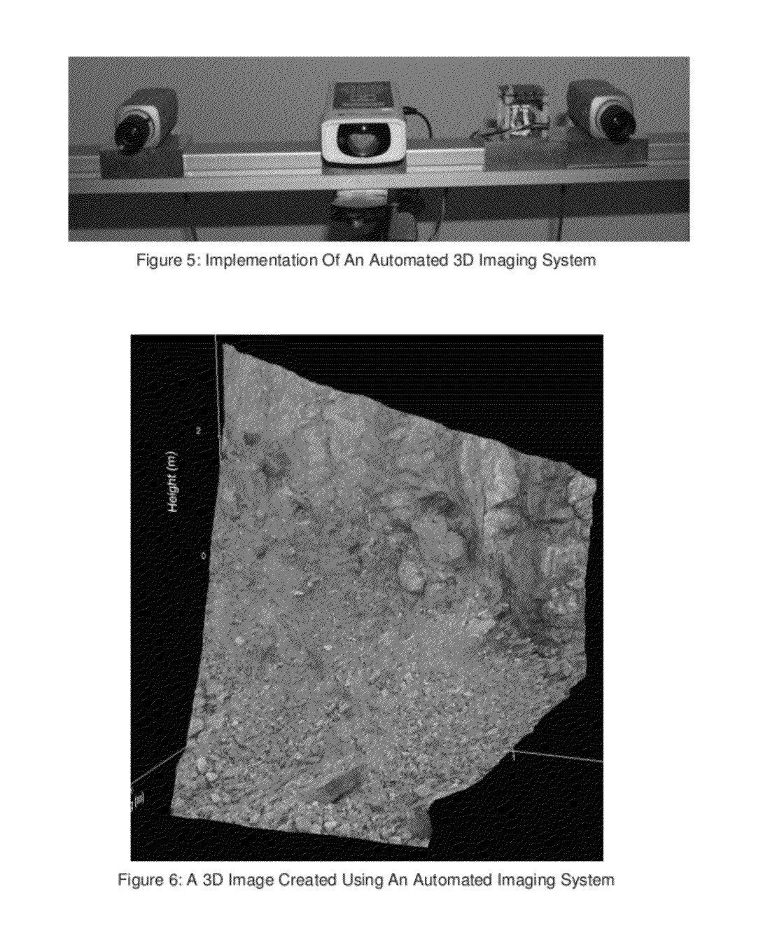

FIG. 5 is a photograph illustrating one practical implementation of a 3D image sensing apparatus according to the present invention. The range sensor is shown at the centre. The devices to the left and right are digital cameras. It will be understood that the relationship between the cameras and the image sensor is known and can be controlled to a high level of precision. As a consequence, the geometric relationship between the three sensing components is known and can be routinely factored into the image processing.

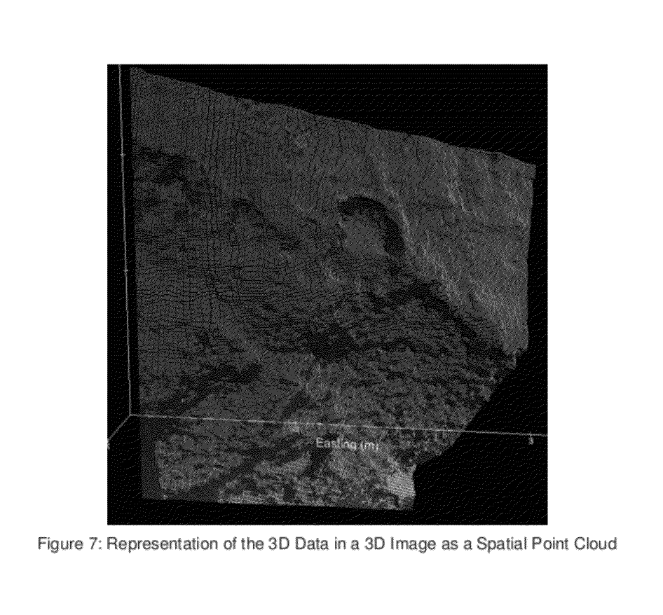

FIG. 6 illustrates a 3D image produced by the system of FIG. 5. FIG. 7 shows the same 3D image data, represented as a spatial point cloud.

A general process for creating a 3D image using two overlapping images according to one implementation of the present invention is:
1. The sensor system acquires two overlapping digital images of the scene from which the 3D image is to be created.
2. The processing system corrects each image to remove or minimise the effects of lens distortion.
3. The sensor system acquires one or more measurements of range to objects in the scene. For a single measurement this will usually be to whatever object is at the centre of the field of view.
4. The processing system uses knowledge of the relative position and orientation of the cameras to determine the degree of horizontal overlap of the digital images. For example if the distance to objects in the scene is large in comparison to the separation of the cameras and the lines of sight of the cameras are parallel (or nearly so) the overlap will approach 100 percent of the image width.
5. The processing system uses knowledge of the relative position and orientation of the cameras to determine the degree of vertical overlap of the digital images. As is well known in the prior art, if the relative lines of sight of the cameras are known the vertical alignment of the image planes is determined by the epipolar geometry.
6. Using knowledge of the horizontal and vertical overlap the area of each image that is to be processed to determine the stereo disparity is determined by the processing system.
7. The processing system thus searches the processing area in each image and identifies the disparity between corresponding points in each image.
8. Using the knowledge of the relative position and orientation of the lines of sights of the cameras the processing system converts the disparity information into a spatial location relative to the cameras and thus creates a 3D image.

It will be understood that the present invention may be implemented using alternative constructions and additional features to those specifically disclosed, but that the present invention encompasses such alternatives.

1. A method for processing sets of two dimensional image data obtained from at least a first and a second two-dimensional image of an object acquired using one or more image sensors located at a first position and a second position so as to produce three dimensional surface data, the method including at least the steps of:
(a) acquiring range data by directly measuring a distance from the one or more image sensor to at least one specific object and feature in each two dimensional image;
(b) determining relative displacement of the one or more image sensor at the first and the second positions;
(c) processing two dimensional image data using the directly measured distance of the acquired range data and the relative displacement to initiate and control determination of correspondences between the two dimensional image data so as to produce processed image data; and
(d) integrating said processed image data to produce three dimensional surface data.

2. A method according to claim 1, wherein processing the two dimensional image data includes the construction of a disparity map defining a displacement of image features between the two images.

3. A method according to claim 2, wherein the processing the two dimensional image data includes using the relative displacement and the range data to control termination of the processing used to create the disparity map.

4. A method according to claim 1, wherein the first and the second images are acquired using the one image sensor moved to a first and a second position.

5. A method for automatically generating three dimensional surface data of an object using one or more two dimensional image sensors, including at least the steps of:
a) obtaining a first image of the object from a first position using a first image sensor;
b) obtaining a second image of the object from a second position using a second image sensor;
c) directly measuring distance from the first image sensor to a point in a field of view of the first image to obtain a distance measurement;
d) determining relative displacement of the first and second positions;
e) using at least the distance measurement from the first image and the relative displacement of the first and second positions to guide the initiation of a search for correspondences between the images to initiate the construction of a disparity map defining the displacement of image features between the two images;
f) using the relative displacement of the first and second positions and the distance measurement to control the processing used to create the disparity map;
g) using the relative displacement of the first and second positions and the distance measurement to control termination of the processing used to create the disparity map; and
h) thereby constructing three dimensional surface data.

6. A method according to claim 5, wherein more than two images are obtained and used to create the disparity map.

7. A method according to claim 5, wherein more than one distance measurement is obtained.

8. A method according to claim 5, wherein one or more distance measurements are also made from at least the second image sensor to a point in the field of view of the second image.

9. A method according to claim 5, wherein the first and second images are obtained by a single image sensor which is moved between two positions.

10. Apparatus for constructing three dimensional surface data, from sets of two dimensional image data, said apparatus including:
one or more two-dimensional image sensors for obtaining at least two images of an object from at least a first and second position,
at least one range sensor for obtaining a distance measurement by directly measuring a distance from the image sensor to a point in a field of view of each of the images, said image sensors and range sensor arranged so as to operatively maintain a specific physical relationship,
a processor adapted to receive data from the one or more image sensor and from said range sensor, such data including a set of two dimensional image data from the one or more image sensor, range data including the distance measurement from the image sensor to at least one specific object and feature in each two dimensional image, and the relative displacement of the first and second positions of the image sensor;
said processor being adapted to process the two dimensional image data using the directly measured distance of the at least one range sensor and the relative displacement of the first and second positions of the image sensor to initiate and control determination of correspondences between said sets of two dimensional image data so as to produce processed image data;
the processor being further adapted to integrate said processed image data to produce three dimensional surface data.

11. Apparatus according to claim 10, wherein the at least two images are provided by a single image sensor which is moved between two or more positions.

12. Apparatus according to claim 10, wherein the at least two images are provided by two or more image sensors.

13. Apparatus according to claim 10, wherein the range sensor is a range measurement device in a digital camera.

14. Apparatus according to claim 13, wherein the digital camera and the image sensors are the same device

15. Apparatus according to claim 10, wherein the range sensor is a device which projects a known pattern of light into the scene containing the object.

16. A method according to claim 1, wherein the distance measurement in (a) is obtained by using a range measurement device in a digital camera.

17. A method according to claim 16, wherein the digital camera is the image sensor which has obtained the first and/or second two-dimensional image of the object.

18. A method according to claim 1, wherein the distance measurement in (a) is obtained by projecting a known pattern of light into the scene containing the object.

19. A method according to claim 5, wherein the distance measurement is obtained by using a range measurement device in a digital camera.

20. A method according to claim 19, wherein the digital camera is the first or second image sensor which has obtained the first and/or second two-dimensional image of the object.

21. A method according to claim 5, wherein the distance measurement is obtained by projecting a known pattern of light into the scene containing the object.
